(19) United States
(12) Patent Application Publication
(10) Pub. No.: US 2018/0018646 A1
(43) Pub. Date: Jan. 18, 2018

(54) FRONT END TRANSACTION SYSTEM

(71) Applicant: BADR M. AL REFAE, Chennai (IN)

(72) Inventor: BADR M. AL REFAE, Chennai (IN)

(21) Appl. No.: 15/541,815

(22) PCT Filed: Jan. 4, 2016
(86) PCT No.: PCT/IN2016/000005

§ 371 Date: Jul. 6, 2017

(30) Foreign Application Priority Data
Jan. 23, 2015 (IN) 348/CHE/2015

(51) Int. Cl. G06Q 20/10; G06Q 20/20; G06Q 20/34

(52) U.S. Cl. CPC G06Q 20/1085; G06Q 20/34; G06Q 20/202; G06Q 20/206

(57) ABSTRACT

The present invention relates to system and methods for processing, monitoring, alerting, managing and accessing services and making payments using mobile devices and access keys at physical and virtual points through issuer provided accounts. More particularly, the present invention relates to a unique front-end transaction system (FETS), which can be customized by a user or an organization according to their needs. Further, the present invention reduces transactions costs by reducing number of payment networks layers between consumers, financial institutions and providers of goods arid services. Also, the present invention eliminates the need to use physical card to gain access to automated teller machines (ATMs) and other financial and non-financial services thereby reducing the security risks associated with the use of physical cards which results in reducing the charge backs to merchants.

### FIELD OF INVENTION

The present invention relates to system and methods for processing, monitoring, alerting, managing and accessing services and making payments using mobile devices and access keys at physical and virtual points through issuer provided accounts. More particularly, the present invention relates to a unique front-end transaction system (FETS), which can be customized by a user or an organization according to their needs. Further, the present invention reduces transactions costs by reducing number of payment networks layers between consumers, financial institutions and providers of goods and services. Also, the present invention eliminates the need to use physical card to gain access to automated teller machines (ATMs) and other financial and non-financial services thereby reducing the security risks associated with the use of physical cards which results in reducing the charge backs to merchants.

### BACKGROUND OF INVENTION

Generally, enterprises and organizations expose their business information and functionality on the web through software applications, usually referred to as web applications. Web applications provide great opportunities for an organization. The web applications use the Internet technologies and infrastructures. The popularity and accessibility of the Internet have been made possible by rapid advances in telecommunications.

New technologies and solutions are being developed at a very fast pace and businesses are under constant pressures to keep up with the fast-changing trends to stay competitive and updated. As more and more people, businesses and organizations connect to the Internet, consumers demand more and more services. Currently a person is overwhelmed and many a times confused with the explosion in the mobile device applications and the services it provides.

FIG. 1, is a block flow diagram of Front-End Transaction System (FETS) according to the prior art for making merchants payments and ATM transactions pursuant as illustrated-with four different transaction examples.

### Example 1: Illustrates how a Consumer/User Makes Bill Pay Either Through their Financial Institution or Through a Biller/Bill Aggregator

In processes 1, 2 and 3, the consumer/user accesses their financial institution account that allows him to select for paying the bills updated by the biller/bill aggregator or allows the sending of payment to the billers/bill aggregators that the consumer/user has already added to their bill pay module. In process 4, the financial institution delivers the payment to the biller/bill aggregator.

### Example 2: Illustrates how a Consumer/User Makes Bill Pay Through their Biller/Bill Aggregator

In process 1, the consumer/user accesses their bills through a link provided by the biller/bill aggregator and selects the bill or bills for payment. In process 2, the biller sends the consumer's/user's payment details to the payment networks for payment approval request. In process 3, the payment network directs the biller's payment approval request to the consumer's/user's account issuer financial institution. In processes 4 and 5, the consumer's/user's issuer financial institution sends the response to the biller/bill aggregator through the payment networks.

### Example 3: Illustrates how a Consumer/User Makes Traditional ATMs/Merchant Transactions

In process 1, two situations are depicted. The first is where the consumer/user receives a bill from the merchant at the physical checkout counter and hands over his payment card and required IDs. The second is where the consumer/user accesses an ATM by inserting his payment card into the ATM card reader device and enters his pin using the pin pad to authenticate himself, in both said situations once the consumer/user is authenticated either manually by the Point Of Sale (POS) attendant, or through an ATM network, a transaction message approval request is then sent in process 2 to the acquirer institution; who has provided the merchant with the electronic funds transfer point of sale (EFTPOS) devices and/or the payment gateway, and in the case of the ATM transaction, the institution who is acquiring the transaction from the consumer/user.

In processes 3 and 4, the acquirer sends the consumer's/user's payment approval request to the payment networks that in turn send it to the consumer's/user's financial institution who issued the payment card. In process 4, the issuing financial institution processes the payment and sends back, in process 5, the processing result response message to the sender through the payment networks, who in turn, in process 6, sends it to the acquirer. Finally, in process 7, the acquirer sends the response of the transaction approval request processed by the issuing institution to the merchant who accepted the payment from the consumer/user. In process 8, the result of either accepting or denying the payment is communicated to the consumer/user.

### Example 4: Illustrates how a Consumer/User Makes ATM/Merchant Transactions Using Mobile Device

In process 1, two situations are depicted. According to the first situation 1A, where the consumer/user receives in their mobile device through some data capturing method like scanning a transaction token from the merchant at a physical checkout counter identifying the merchant and the transaction being processed for the consumer/user. According to the second situation 1B, where the consumer/user accesses an ATM by selecting a mobile transaction on the ATM screen, which generates an ATM code and in 2B transmits the code to a transaction management system server.

According to the third situation 1C, where the consumer/user capturers using their mobile device, an ATM or POS identifier on the machine screen or on the physical ATM or POS device. The data captured in 1A and 1C in the consumer's/user's mobile devices is then sent in processes 2A and 2C using the mobile device to the transaction management system after authenticating the consumer/user and/or their mobile device to the transaction management system. Once all the transaction identifying information is received by the transaction management system in 2A, 2B or 2C through any of the three situations 1A, 1B or 1C, the transaction management system in process 3A accesses the merchant transaction queue server and pulls the transaction data, validate it and sends along with the consumer's/user's payment card details available in the transaction management system for payment processing in processes 4 and 5. In process 3B, the transaction management system generates a transaction token and sends it to the ATM in response to the consumer's/user's selection in 1B of mobile transaction on the ATM screen.

In process 3C, the transaction management server generates a transaction token and sends it to the ATM or POS device in response to the consumer's/user's data captured in 1A and 1C. At this stage, in process 3D, the consumer/user will capture this transaction token from the ATM screen or POS device and send it in 3E to the transaction management system. The transaction management system will use this transaction token along with the consumer's/user's payment card details available in the transaction management system to process the transaction after validation and send it for payment processing in processes 4 and 5. In process 6 and 7, the result of either accepting or denying the payment is communicated to the transaction management system. Finally, in processes 8 and 9 the transaction process result is sent to the merchant POS or ATM devices and the consumer's mobile device.

Some of the prior arts are:

U.S. Pat. No. 8,635,157 is using a mobile phone via a consumer mobile software application (CMA) in lieu of a consumer card such as physical, virtual, or chips to conduct payment transactions in the real or virtual world of commerce. An embodiment is related to making payments to real-world stores via having the CMA on a mobile device on behalf of the consumer present to conduct transactions and no physical card required.

U.S. Pat. No. 8,632,000 discloses a method for operating a mobile device to complete a transaction between an account holder and an automated teller machine (“ATM”), the method comprising: causing an ATM code to be captured by the mobile device, the ATM code presented to the account holder at a location of said ATM; transmitting, to a remote transaction management system, a transaction request message including information associated with said ATM code; receiving, from said transaction management system, information identifying a list of available transaction accounts associated with said account holder; transmitting, to said remote transaction management system, information identifying a selected transaction account associated with said account holder for use in said transaction; and receiving, from said transaction management system, instructions to complete said transaction.

WO2012168940 discloses a transaction system constituted of: a mobile device comprising a display; a transaction server; and a communication network arranged to provide communication between the mobile device and the transaction server wherein the mobile device is arranged to transmit identification information to the transaction server via the communication network and wherein the transaction server is arranged to: identify the mobile device responsive to the mobile device transmitted identification information; associate the identified mobile device with a particular access point; transmit via the communication network transaction information to the mobile device the transmitted transaction information responsive to the associated particular access point.

US20110238573 discloses a method and system are provided for conducting automatic teller machine (ATM) transactions without the use of an ATM card, using a mobile user device. The mobile user device communicates with an ATM, a provider interface or a network. The ATM communicates with the mobile user device through a contact or contactless means, which may include communication through any wireless connection such as RFID, Bluetooth™ or other near field communication means, or through a USB port or other means of contact.

Accordingly, there exists a need for a unique customizable front-end transaction system (FETS), which can be customized by a user or an organization according to their needs such as processing, monitoring, alerting, managing and accessing services and making payments using portable devices and access keys at physical and virtual points through issuer provided accounts.

### Keywords

The following are keywords and their descriptions referred to in this document:

Front End Transaction System FETS: FETS in which a consumer/user use to access other FETS that may include personal, non-governments and governments organizations for personal and/or official purposes.

FETS Networks: Networks that result from connecting a single and/or multiple FETS and/or networks to a single and/or multiple FETS network and/or networks.

Global Front End Transaction System (GFETS): GFETS hosts private and publicly listed FETS and/or their Directories.

GFETS Networks: Networks that result from connecting a single and/or multiple GFETS and/or networks to a single and/or multiple GFETS network and/or networks.

FETS Directory FETSD: The FETS automatically sets up a FETS Directory (FETSD) for every FETS. All Contacts Points called CPs whether human, physical or virtual updates a user's FETSD. The user has a choice to create private or public FETSDs and list them in the Global Front End Transaction System Directory (GFETSD) which contains all or parts of a user's FETS directories or FETS directories a user controls.

GFETSD: GFETSD provides databases containing virtual links with search engines for public and private listings of Front End Transaction Systems Directories (FESTDs). The GFETSD is hosted by the Global Front End Transaction System GFETS and publicly listed FETSDs are accessible by all FETS users. The GFETSDs private listings are only accessible by the authorized FESTS through secured access channels.

Transaction Message (TM): TM is a message that is automatically generated by the FETS each time a transaction is processed by FETS.

Transaction Message Protection (TMP): Transactions made more secure by generating keys, pins and/or security questions. Multiple keys and/or pins can be generated for each secured transaction.

User: User refers to any user or system owner of a FETS, which can be an individual consumer or a user within an organization.

Unique Identifier: Unique identifier is any unique reference that can identify an account, an account holder, a device, a physical or a virtual location.

Data Elements: Any transaction data defined by the FETS. Examples: CPs, page, account issuer, customer, file, category, type, sales, and profits, etc.

Object Elements: are Virtual Containers that can contain any virtual thing or links including links to live streams and feeds i.e. data, video, audio, text, Interactive Voice Response (IVRs), with embedded web services, and/or services, devices and software programs connected over networks. Each Object and its contents are uniquely identified for ACCESS, security and licensing purposes. The Object can be visible or hidden on the IP network. Each Object can be configured by a User to define how the Object is accessed and shared and the type of contents it can store. Objects can LINK and CONNECT to other objects over networks forming Objects Networks. Objects, can create Sub Objects that are attached to a root or a Master Object. More than one root or Master Objects can be created. The Object data and Apps can be stored physically or by reference (Link—URL/URI) based on user's settings for different data and apps. If set by reference, then the actual file is not stored and only the link reference will be stored and while accessing the content of a file or. App, the content is actually read from the original source.

Intelligent Object Elements: are Programmable Object Elements

Self-Programmable Intelligent Object Elements: are Programmable Object Elements that are capable of automatically programming itself.

Internet of Objects: are Object Elements, Intelligent Object Elements, Self-Programmable Intelligent Object Elements collectively referred to herein as Objects and/or networks of Objects that are capable to transfer data or execute programs over a network or networks with and/or without requiring human-to-human or human-to-computer interaction.

Manage Elements: Any keywords or short commands to manipulate data elements, object elements, system elements or transactions generated by the front end system, examples: link, configure, monitor, auto, check, ads, cancel, edit, delete, add, copy and paste, print, save, save as, share, post, block, hold, recall and reverse; etc.

System Elements: System element is collectively referred to any or all the transactions, services, pre-services, physical and virtual points, Object Elements, data and manage elements of the FETS.

FETS Knowledge Database FKD: It consists of all active and non-active FETS system elements. All conditions, auto-processes, rules and other services are tagged and searchable and can be queried by any FETS service or user.

Create: It is used to generate a new non-existing system element.

Add: Add is used to activate or bring into FETS an existing system element that has already been created by FETS.

Services: Any programmed services. Examples: pay, pre-pay, pre-services, pre-serviced, access, conditions, connections, host, call, send, receive, and answer.

Pre-Services and Pre-Serviced: Pre-Services are any services that are offered as a pre-service. When pre-services are pre-processed for authorization, payment, or both and provided with keys to redeem the pre-processed services then the pre-services becomes pre-serviced.

Issuer: Any virtual or physical card account issuer who can be a financial or non-financial institution where an account holder can virtually access the issued accounts over networks.

Acquirer: Any virtual or physical service provider who can be a financial or non-financial, institution where the services it provides is made available to participating account issuers and/or networks.

Third Party Front End Transaction System FETS: Any institution who processes virtual or physical access requests on behalf of Issuers, acquirers and/or networks.

Contact Points (CPs): A collective term that refers to any type of contact that is represented in a form of a name and/or a virtual link to a person, an organization, a physical point and/or a virtual point. CP can made up of single CP, multiples, and/or groups and sub-groups of CP(s). Examples of CP(s) are names of individuals, organizations, addresses, virtual links to physical and virtual points, links to FETS, FETSDs, folders and items such as profiles, walls, bills, photos, music, documents, etc. Also folders or virtual links may contain virtual links to other CPs and physical devices such as ATMs, cars and/or door locks.

FETS Monitor: It refers to the front end transaction system monitor services that monitors all FETS transactions and the monitored system elements.

Transaction Monitoring: It is a FETS transaction monitor service that monitors transactions processed by FETS.

Process Monitoring: It is a FETS monitor service that monitors the execution of a process as opposed to a transaction.

Transact: It is a FETS Transaction Switch (TS) implemented as a service that authenticates, processes, routes and logs all FETS incoming and outgoing transactions.

FETS Alerts: It refers to FETS alerts services that sends alerts for monitored transactions and processes. The alerts can be sent using delivery channels setup by a FETS user using any of the communications channels supported by his FETS or available to his FETS by other FETS.

Virtual Points: Any virtual location or address that can be accessed via the Internet or Networks.

Physical Points: Any physical devices or machines that can be physically accessed and unlocked via the Internet or Networks.

Billers: It refers to any person or institution that sends their bills using FETS.

### Objects of Invention

One or more problems of the prior art may be overcome by various embodiments of the system and methods of the present invention.

It is the primary object of the present invention to provide a unique Front-End Transaction System (FETS), which can be customized by a user or an organization according to their needs using portable devices and access keys at physical and virtual points through issuer provided accounts.

It is another object of the present invention, wherein the portable device includes but not limited to mobile device or a tablet, an iPad, and other similar devices or a computer terminal or any other computer devices.

It is another object of the present invention to provide a unique and customizable FETS, which reduces transactions costs by reducing number of payment networks layers between consumers, financial institutions and providers of goods and services.

It is another object of the present invention to provide a FETS, which provides a simple and direct payment that is consumer/user centric and preserves a direct relationship between the consumer, a service provider and a financial institution.

It is another object of the present invention, wherein the FETS enables billers to generate a Transaction Message (TM) that contains all information to electronically send a bill to a receiver, which could be a consumer, a business or any organization.

It is another object of the present invention, wherein the consumer for example can pay a bill using his financial accounts issuer's accounts when a bill is received into his FETS, and during ATM transactions, the consumer sends transaction requests directly to bank account issuer to directly or indirectly release the ATM machine services.

It is another object of the present invention, wherein the FETS handles both financial and non-financial services transactions such as gaining access to hotel rooms or cars, virtual and physical entry points, making a reservation and so any physical and/or virtual barrier that can be virtually unlocked and physically or virtually accessed.

It is another object of the present invention, wherein the FETS eliminates the need to use the physical card to gain access to ATM(s) and other financial and non-financial services thereby reducing the security risks associated with the use of physical cards.

It is another object of the present invention to provide a method for processing, monitoring, alerting, managing and accessing services and making payments using FETS, which can be customized by a user or an organization according to their needs.

### SUMMARY OF INVENTION

Thus according to the basic aspect of the present invention there is provided a customizable front-end transaction system (FETS) comprising of:
FETS/Global front end transaction system (GFETS) network;
one or more FETS(s)/GFETS(s);
issuer system;
acquirer system;
one or more transaction switch(s);
one or more physical point(s); and
one or more virtual point(s),
wherein the FETS includes third party FETS, acquirer FETS, issuer FETS, GFETS, and consumer/user FETS,
wherein the system is customized and configured by the user/consumer according to their needs,
wherein the consumer/user connects to the issuer FETS, third party FETS, FETS, acquirer FETS, and GFETS in the FETS/GFETS Networks via wired or wireless communication networks,
wherein the consumer/user login to their account issuer over the Internet or via private networks using a portable device to access their FETS, and
wherein the FETS automatically generates a transaction message (TM) each time a transaction is processed by the FETS, said TM messages are exchanged locally within the FETS and with other FETS over the networks thereby eliminating the need to use physical card to gain access to automated teller machines (ATMs) and other financial and non-financial services.

It is another aspect of the present invention, wherein the user/consumer needs include processing, monitoring, alerting, managing and accessing services and making payments using portable devices and access keys at physical and virtual points through issuer provided accounts.

It is another aspect of the present invention, wherein the TM can be tracked and viewed over the networks using TM details that include a transaction reference, a transaction confirmation reference and/or transaction security keys, passwords and security questions.

It is another aspect of the present invention, wherein all transactions that are logged by a transact logger are updated to FETS Monitor and are monitored with alerts that are customizable by the consumer/user according to the services provided by the FETS monitor and alerts services.

It is another aspect of the present invention, wherein the consumer/user can create private or public FETS Directory (FETSD) and list them in Global Front End System Directory (GFETSD) which contains all or parts of the consumer/user's FESTD or FETSD(s) user controls.

It is another aspect of the present invention, wherein the consumer/user FETS shares their whole FETSD or parts of it with other FETS according to pre-defined sharing rules and conditions created by the consumer/user FETS using their FETS system.

It is another aspect of the present invention, wherein the consumer/users can at any time delete their created FETSD(s) in parts or totally from the GFETSD.

Another aspect of the present invention is directed to provide a method for providing user/consumer needs using customizable front-end transaction system (FETS) comprising steps of:
authenticating/logging into the account issuer or using virtual keys to access Global. Front End System Directory (GFETSD);
searching a POS device based on the user location;
capturing a POS device Unique Identifier (UI) displayed on the physical POS enclosure or on a POS device screen;
receiving the POS device UI link wirelessly to the consumer/user FET;
automatically generating a transaction message (TM), each time when a transaction is processed by the FETS;
exchanging the TM(s) locally within the FETS and with other FETS over the networks;
generating multiple keys for each transaction; and
monitoring transactions and/or processes with alerts that are customizable by the FETS consumer/user through FETS monitor,
wherein the user/consumer needs include processing, monitoring, alerting, managing and accessing services and making payments using portable devices and access keys at physical and virtual points through issuer provided accounts,
wherein the consumer FETS and POS device are connected when the user/consumer clicks the POS device UI link, and
wherein the alerts services for the monitored transactions and/or processes is communicated according to the alerts settings configured by the FETS consumer/user.

It is another aspect of the present invention, wherein the consumer/user controls the processing and payment of the transaction and all accounts information of the consumer/user are kept with their accounts' issuers.

It is another aspect of the present invention, wherein the consumer/user can share their whole FETSD or parts of it with other FETS according to pre-defined sharing rules and conditions the FETS consumer/user creates using their FETS.

### BRIEF DESCRIPTION OF THE ACCOMPANYING DRAWINGS

FIG. 1: illustrates the block flow diagram of the Front-End Transaction System (FETS) according to the prior art.

FIG. 2: illustrates the block diagram of the Front-End. Transaction System (FETS) according to the present invention.

FIG. 3: illustrates the block flow diagram of the Front-End Transaction System (FETS) according to the present invention.

FIG. 4: illustrates the process flow chart of a Front-End Transaction System (FETS) pursuant to some embodiments according to the present invention.

FIG. 5: illustrates the process flow chart of a Front-End Transaction System (FETS) pursuant to some embodiments according to the present invention.

### DETAILED DESCRIPTION OF THE INVENTION WITH REFERENCE TO THE ACCOMPANYING FIGURES

The present invention is thus directed to a unique front-end transaction system (FETS), which can be customized by a user or an organization according to their needs. Further, the present invention reduces transactions costs by reducing number of payment networks layers between consumers, financial institutions and providers of goods and services.

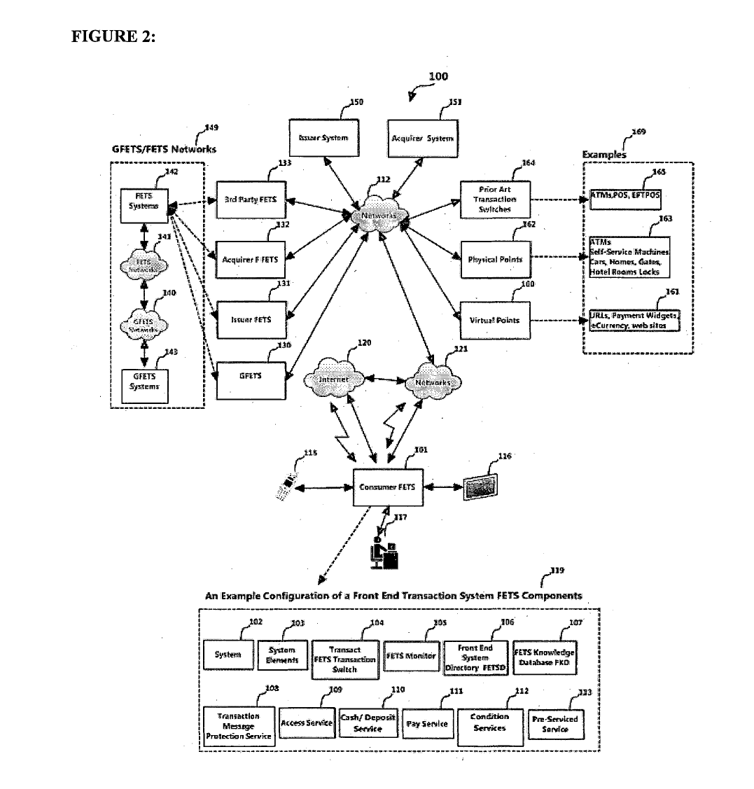

Referring to FIG. 2, the FETS [100] comprising of FETS/GFETS network [149]; one or more

FETS(s)/GFETS(s) [130] [131] [132] [133]; issuer system [150]; acquirer system [151]; one or more transaction switch(s) [164]; one or more physical point(s) [162]; and one or more virtual point(s) [160]. The FETS includes third party FETS [133], acquirer FETS [132], issuer FETS [131], GFETS [130], and consumer/user FETS [101], said consumer/user FETS [101] further comprising of a FETS version system [102] which is customized and configured by the user/consumer, system elements [103], transact FETS transaction switch [104], FETS monitor [105], FETS Directory (FETSD) [106], FETS Knowledge Database (FKD) [107], transaction message protection service [108], access service [109], cash/deposit service [110], pay service [111], condition services [112]; and pre-serviced service [113]. The consumer/user connects to the issuer FETS [131], third party FETS [133], FETS [142], acquirer FETS [132], and GFETS [143] in the FETS/GFETS Networks [149] via wired or wireless communication networks [120] [140] [142].

The FETS [131] [132] [133] automatically generates a transaction message (TM) each time a transaction is processed by the FETS [131] [132] [133], said TM messages are exchanged locally within the FETS [131] [132] [133] and with other FETS over the networks. The TM can be tracked and viewed over the networks [120] [121] using a transaction reference, a transaction confirmation reference and/or transaction security keys, passwords and security questions. The TM structure consists of seven components such as transaction reference, sender, recipient, description, confirmation reference, details reference, and security. The reference number is the transaction reference number that identifies a transaction generated by the sender FETS System. The TM details are transaction dependent.

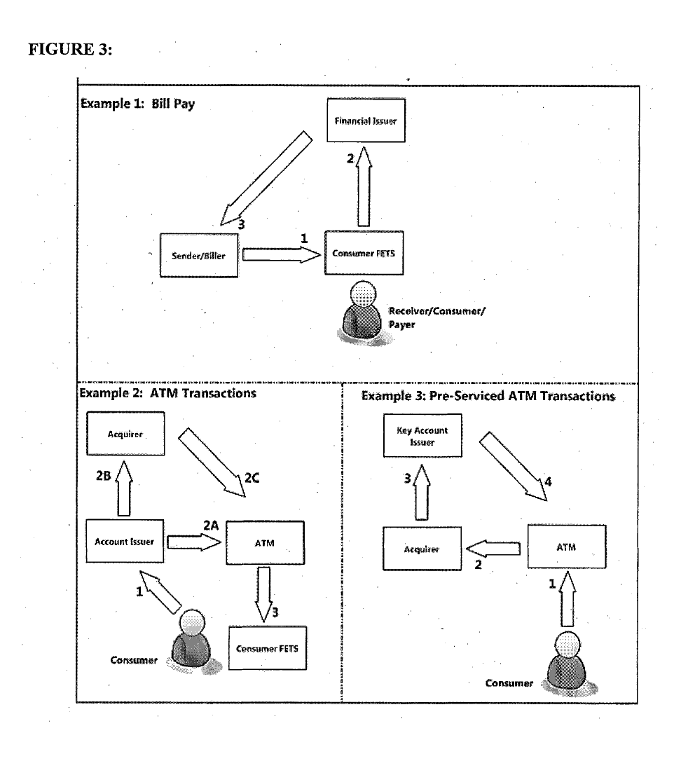

Referring to FIG. 3, for illustration, if the transaction processed by a FETS is generated by a biller who intends to send a bill to a receiver for payment, the TM will be constructed differently from TM message that requests access to a device or an ATM machine. The biller's message, for example contains bill reference and amount, biller ID and bank name and account number, bank transfer details, etc. of the biller to enable the bill recipient to instruct their bank to pay the biller.

Transactions are made more secure by generating keys, passwords and security questions. Multiple keys can be generated for each transaction. If keys are generated for a particular transaction then this transaction can only be processed using said keys. Also the transactions can be further secured by adding password protection that is required to be provided at the time of transaction processing. The transactions have keys, passwords and/or security questions, said keys are one time and/or permanent until voided or changed or time lived.

Referring to FIGS. 2 to 4, the FETS automatically sets up the FETS Directory FETSD [106] for every FETS(s) [131] [132] [133] system. All Contacts Points (CPs) whether human, physical or virtual updates the consumer/user's FETSD [106]. The consumer/user has a choice to create private or public FETSD(s) and list them in the Global Front End System Directory (GFETSD) which contain all or parts of the consumer/user's FESTD or FETSD(s) [106] user controls, said FETSD(s) [106] do not contain any private or personal contents except virtual links, which are basically virtual locators. The consumer/users have choices of where to locate the contents; which can be located in a consumer/user FETS [101], FETS consumer/user controls, GFETS [130] or other FETS including third party FETS storage providers.

Depending on how the links are setup FETS [101] consumer/users secure the links to a desired security protection level or leave the virtual links with the default security settings. The FETS [101] consumer/user can also share their whole FETSD [106] or parts of it with other FETS according to pre-defined sharing rules and conditions created by the consumer/user FETS [101] using their FETS System. The FETS [101] consumer/user can manage their FETSD [106] contents and link them to their FETS system elements [103] includes but not limited to virtual and physical points and pages.

The GFETSD provides virtual links databases with search engines for public and private listing of the FETS. The Global Front End Transaction System GFETS [130] hosts the GFETSD. Publicly listed FETSD(s) [106] are accessible by all consumer/user FETS [101]. The FETSD(s) [106] private listings are only accessible by the authorized consumer/user FETS [101] across the FETS networks. The consumer/users can at any time delete their created FETSDs [106] in parts or totally from the GFETSD. The publicly listed FETSD(s) [106] are archived and available for public access for the time specified by the FETSD [106] creators and according to the terms of use of the GFETS [130].

The main advantage of the GFETSD listed FETSD(s) [106] is that it provides the consumer/user with a very simple process of sharing and managing the FETS system elements [103] and attached links. When the other FETS [101] consumer/users connect and access other consumer/users' listed FETSD(s) [106] in the GFETSD, they view and connect according to the viewing and sharing rules of the FETSD [106] creators. Different consumer/users view and/or access differing parts of a listed FETSD [106] depending on the rules, conditions and access privileges granted by the FETSD [106] creators.

A transact for short is an intelligent media transaction switch (TS) [104] that routes, authenticates, logs all the services, applications and data that are accessed via a FETS as shown in FIG. 2. Every transaction is validated and routed based on the pre-defined rule/knowledge base implemented. The FETS services are executed via the transact, said transact also routes or services the request to/from other FETS based on the permissions settings. The routing process performs the logging and authentication. After successful authentication, the transact redirects the virtual location or address in the requested link. The transact provides a method to search and/or retrieve logged records or data based on criteria given by the calling FETS or service. All the transactions are fully monitored with alerts that are customizable by the FETS consumer/user through the FETS monitor and alerts services.

The transact logger logs the transaction details including request and response information for each action or event occurring during a service access using the transact logger. The information logged in the transact logger depends on the type of transaction.

For illustration, financial transactions has additional information on the payment details that accompanies the transaction like transaction reference number, masked account number, approval code, financial institution code, etc. The FETS consumer/user configure in their profile whether to maintain any log data in their. FETS and for how long and can have a choice of categorizing which types of transactions are maintained against his FETS if any. Alternatively, a FETS consumer/user can configure their transact logger to download the transactions to a local device or third party services. The transact logger service allows the consumer/user to use search tools to search the log and export the results to other popular software applications.

The event, date and time of occurrence, method called, etc. are recorded and will be used for monitoring and analysis purposes. Input for the logging method contains log date time, transaction data, service ID and FETS user defined data. Response for the logging method contains success message, failure information, if it is a failure response. The transact performs the following tasks:
1. Communicates between various external FETS Transact switches and internal FETS services comprising of:
   a. Message framing between FETS services within a FETS and with external FETS.
   b. Message processing from the request and response received
   c. Service method references/calling
   d. Logging of messages.
2. Authentication setting, validation and encryption and decryption of messages exchanged between the two FETS.
3. Uses message queuing concept to sequence, validate and prioritize the messages flows.
4. Processing payment processing requests and preparing an authorization approval message request which includes the transaction details like the amount, and the biller ID.

Transact receives a request and passes onto the required service and receives a response to pass on to the calling service. Photos, music and/or documents files and services open with appropriate service page. All links to remote documents or data or services are padded with appropriate local transact link. Routing process in the transact will extract the actual link, and does the logging and authentication of the request and any validation of the pre-defined rules if defined, and once the authentication and validation succeeds, redirects to the appropriate resources requested in the link.

The remote service calls transact remote, logs and authenticates the service methods, to validate the request received, said remote service selects appropriate remote transact link to route, based on pre-defined criteria or validations set by the FETS consumer/user specified in the message structure. Routing service uses the transact logger service to log all the routing activities.

The FETS monitor [105] is updated with all the FETS transactions by transact which is a FETS transaction switch service. Two types of FETS monitoring services are provided by the FETS monitor [105] consisting of:
Transact monitor, which monitors the entire FETS incoming and outgoing transaction message exchanges, all transactions that are logged by said transact logger are updated to FETS Monitor [105] and are monitored according to the services provided by the FETS monitor [105].
Process monitor, in which the consumer/user creates a new process or activate an existing process using FETS [101]. Each process to be monitored is identified by a unique process Identifier and/or a name to identify the specific process to be monitored by the FETS [101]. The process is defined and setup by the consumer/user. FETS [101]. Once the process is setup by the FETS [101] consumer/user, any transactions that access the monitored process are monitored and displayed on the FETS monitor [105] dashboard.

For illustration, using the FETS monitor, the FETS consumer/user through FETS manages, selects the system element or group of elements the consumer/user desires to monitor. Whenever a transaction involving the monitored system elements is processed by the FETS, the processing output results are actioned according to the conditions setup by the FETS consumer/user and update the FETS Monitor which can be displayed in real time on the FETS Monitor dashboard.

The FETS monitor service also provides alerts services for the monitored transactions and/or monitored processes which are communicated according to the alerts settings configured by the FETS consumer/user. The alerts messages are delivered using the default setting or the consumer/user setup custom delivery channels and/or pre-defined conditions using FETS.

Referring to FIG. 3,

### Example 1

Using a portable device [115] [116] [117], the consumer/user runs the access service [109] as shown in FIG. 2 and either logs in to the account issuer they desire or alternatively, selects pre-serviced from the menu options and uses the virtual keys sent to him to access the GFETSD. The following are examples of the different ways the consumer/user connect to a POS device.
Searches or discovers the POS device. The consumer/user shares their GPS location with the GFETS System [143] to expedite the device locating process.
Captures the POS device Unique Identifier (UI) displayed on the physical POS enclosure or on a POS device screen.
Receive wirelessly, for example through a Wireless Fidelity (Wifi) or. Near Field Communication (NFC) port, the POS device UI.
Receive the POS device UI Link through an Email, SMS, social media, or a FETS Post. Once the consumer/user and the POS device are connected, through any of the above mentioned delivery channels, the biller in process 1, sends a bill directly to the consumer's/user FETS. In process 2, the consumer/user receives a bill from a biller, runs the pay service [111] as shown in FIG. 2 and pays the bill. In Process 3, the financial issuer sends the payment to the biller.

### Example 2

Using a portable device [115] [116] [117], the consumer/user runs the access service [109] as shown in FIG. 2 and either logs in to the account issuer they desires or alternatively, selects pre-serviced from the menu options and uses the virtual keys sent to him to access the GFETSD. The following are examples of the different ways the consumer/user connect to an ATM or any networked device.
Searches or Discovers the ATM or device. The consumer/user shares their GPS location with the GFETS System [143] to expedite the device locating process.
Captures the ATM or device UI displayed on the physical ATM/device enclosure or on an ATM/device Screen.
Receives wirelessly, for example through a Wifi, NFC, Bluetooth, etc. ports, an ATM/device UI.
Receive a device UI link through an Email, SMS, social media, or a FETS post. In process 1, the consumer/user and an ATM/device are connected through any of the above mentioned delivery channels. In process 2 the consumer, through the access service, gains access to the ATM at the physical location either directly in [2A], if the ATM acquirer and issuer are the same or indirectly [2B] or [2C] if the ATM acquirer and issuer are different. In process 3, the ATM services are released to the consumer/user through the access service. If the consumer/user has requested a cash or deposit transaction then, the consumer/user is directed to the cash/deposit service [110] as shown in FIG. 2 to dispense cash or deposit cash or checks.

### Example 3

To gain access to the ATM machine to get cash that was pre-serviced, the consumer/user selects pre-serviced and then selects dispense cash on the ATM screen. The ATM Acquirer FETS prompts the consumer/user to enter the pre-serviced keys into the ATM virtual or physical pin pad. Once the keys are entered by the consumer, it is received, in process 2, by the ATM acquirer. In process 3, the ATM Acquirer generates an approval request message that is sent to the key account issuer FETS by first deciphering the key account issuer ID and accessing the GFETSD to get the key account issuer virtual link. Finally in process 4, once the key account issuer approves the transaction, the acquirer FETS instructs the ATM to deliver the cash to the consumer.

### Example 4

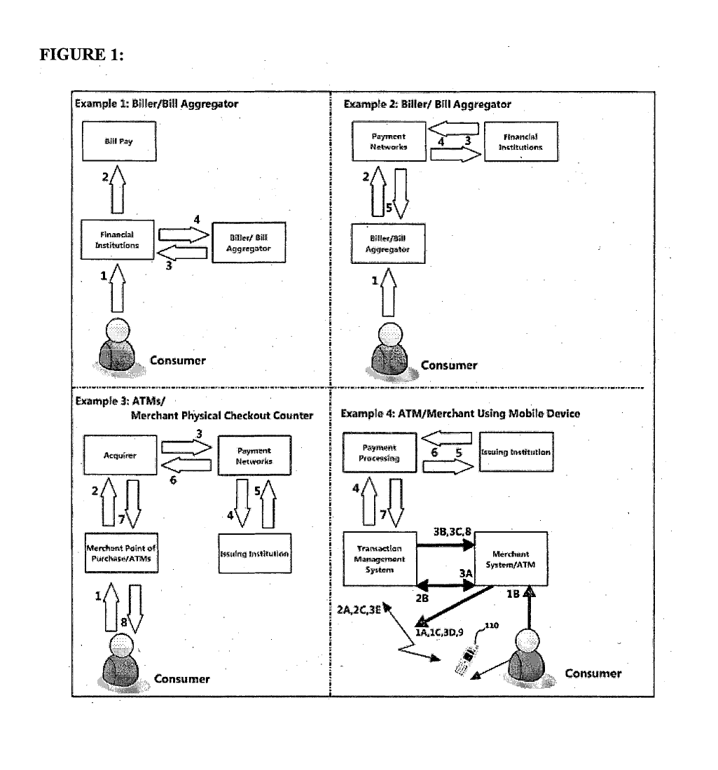

The consumer/user using their portable device to gain access to a car, home or office entrance and runs the access service [109] as shown in FIG. 1 and selects physical point from the displayed menu option on their portable device and either logs into the account issuer they desires or alternatively selects pre-serviced from the menu options and uses the virtual keys sent to them to access the GFETSD. Once the account issuer approves the transaction, the acquirer FETS instructs the device to unlock and allows user access to a car, a home or office entrance.

### Example 5

FETS user 1 posts a link, with the bill he paid using FETS, to their FESD hosted at the GFETSD and shares it with another FETS user 2. The user 2 will get alerted of the posting by user 1, through FETS alerts, and access the bill sent by user 1. Once user 2 accesses the link sent by user 1, user 1 can get alerted and can view the receipt details sent by user 2 using the confirmation generated by user's 2 FETS. If user 1 chose to share the link with other FETS users, then user's 1 FETSD will send postings according to the sharing rules and conditions created by user 1 for the shared FETS users.

### Example 6

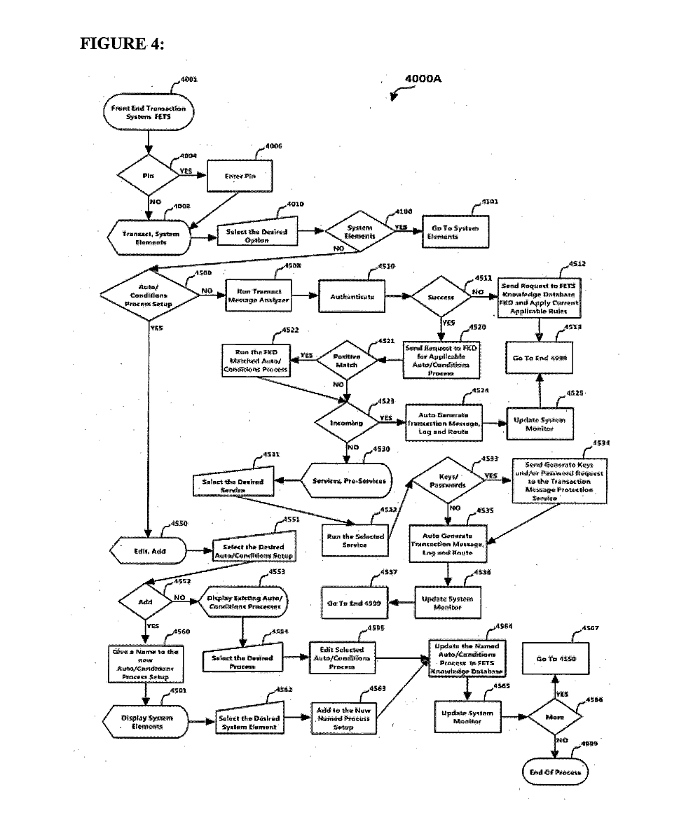

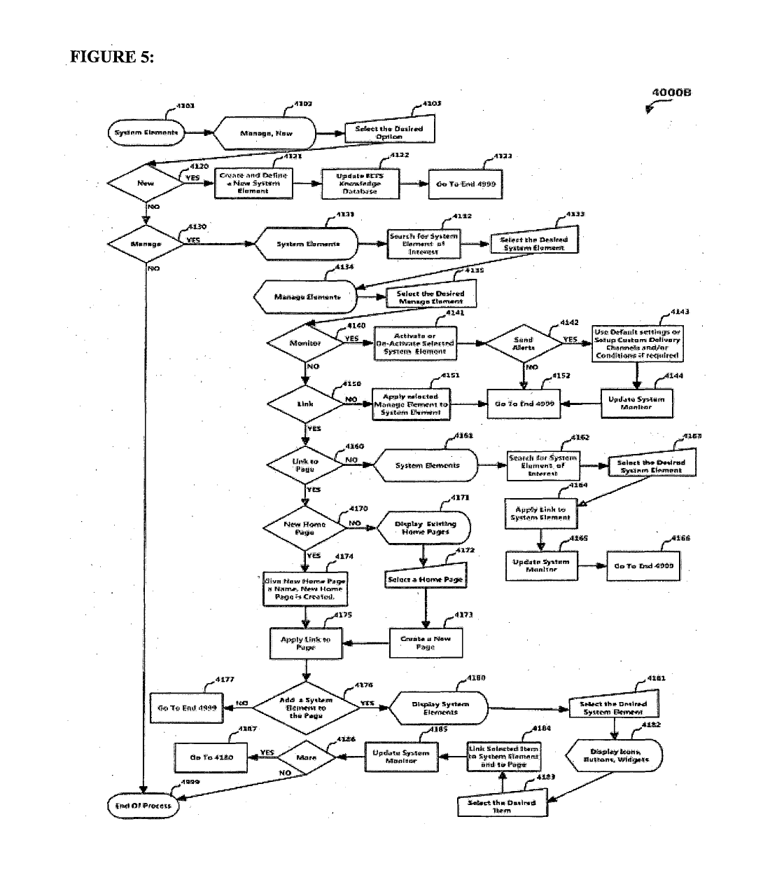

Referring to FIGS. 4 and 5, the FETS user 1 creates a home page and link said home page to a contact point ABC. The user 1 follow the process as shown in FIGS. 4 and 5, and add physical and virtual links or system elements to the ABC home page. The ABC home page that has now been created by the user 1 for ABC can contain links to a customized answer page which can be added to the ABC home page following the logic as shown in FIG. 5 for adding pages and system elements. ABC answer page is displayed to user ABC whenever the user ABC communicates with the user 1.

The answer page display for all communication channels between user 1 and user ABC or can be restricted to certain communication channels like, chat, voice calls, unanswered voice calls, and/or emails. As system elements linked to the ABC user page are updated in the user's 1 FETS, user's ABC answer home page, containing the same system elements created by the user 1 for ABC Answer Page, also get updated if the user 1 desire using the user's 1 FETS.

### Example 7

Using the FETS for an organization, the user 1 monitor the work flow for their entire organization or for a certain department, section, project and/or assignment depending on how FETS process monitor is used to setup the process monitor. The user 1 setup a new process or use an existing process as shown in the FIGS. 4 and 5. The purpose of the process monitor is to setup a Digitally Secured Approvals (DSA) work flow process monitor. The DSA monitor is achieved by requiring a digital signature from one or several DSA participants before a transaction process is taken to the next level until the whole DSA process is completed for any initiated DSA tasks. Any initiated monitored DSA task will be monitored by the FETS process monitor and updates in the real time FETS monitor dashboard that can be viewed live by the originator, all the process participants and the process owners.

All resources that are required to be informed to monitor the process from beginning to end and can have access to the FETS monitor dashboard. Each authorized entity can only view and monitor the process part they are authorized to view or access. All DSA monitor project participants will receive alerts and their FETS monitors are updated with all the transactions executed by any of the participating consumer/user's FETS involving the monitored process. Monitored processes transactions for completed tasks are archived and searched by the authorized resources using multiple search options, such searchable text, keywords, and/or tags.

The following examples are all for explanatory purposes and are not meant to be restrictive to any part of the system/method of the present invention.

I claim:

1. A customizable front-end transaction system (FETS) [100] comprising of:
FETS/Global front end transaction system (GFETS) network [149];
one or more FETS(s)/GFETS(s) [130] [131] [132] [133];
issuer system [150];
acquirer system [151];
one or more transaction switch(s) [164];
one or more physical point(s) [162]; and
one or more virtual point(s) [160],
wherein the FETS includes third party FETS [133], acquirer FETS [132], issuer FETS [131], GFETS [130], and consumer/user FETS [101],
wherein the system is customized and configured by the user/consumer according to their needs,
wherein the consumer/user connects to the issuer FETS [131], third party FETS [133], FETS [142], acquirer FETS [132], and GFETS [143] in the FETS/GFETS Networks [149] via wired or wireless communication networks [120] [121] [140] [141],
wherein the consumer/user login to their account issuer over the Internet or via private networks using a portable device to access their FETS, and
wherein the FETS [131] [132] [133] automatically generates a transaction message (TM) each time a transaction is processed by the FETS [131] [132] [133], said TM messages are exchanged locally within the FETS [131] [132] [133] and with other FETS over the networks thereby eliminating the need to use physical card to gain access to automated teller machines (ATMs) and other financial and non-financial services.

2. The customizable front-end transaction system (FETS) as claimed in claim 1, wherein the user/consumer needs include processing, monitoring, alerting, managing and accessing services and making payments using portable devices and access keys at physical and virtual points through issuer provided accounts.

3. The customizable front-end transaction system (FETS) as claimed in claim 1, wherein the TM can be tracked and viewed over the networks [120] [121] using TM details that include a transaction reference, a transaction confirmation reference and/or transaction security keys, passwords and security questions.

4. The customizable front-end transaction system (FETS) as claimed in claim 3, wherein all transactions that are logged by a transact logger are updated to FETS Monitor [105] and are monitored with alerts that are customizable by the consumer/user according to the services provided by the FETS monitor [105] and alerts services.

5. The customizable front-end transaction system (FETS) as claimed in claim 1, wherein the consumer/user can create private or public FETS Directory (FETSD) [106] and list them in Global Front End System Directory (GFETSD) which contains all or parts of the consumer/user's FESTD or FETSD(s) [106] user controls.

6. The customizable front-end transaction system (FETS) as claimed in claim 5, wherein the consumer/user FETS [101] shares their whole FETSD [106] or parts of it with other FETS according to pre-defined sharing rules and conditions created by the consumer/user FETS [101] using their FETS system [101].

7. The customizable front-end transaction system (FETS) as claimed in claim 6, wherein the consumer/users can at any time delete their created FETSD(s) [106] in parts or totally from the GFETSD.

8. A method for providing user/consumer needs using customizable front-end transaction system (FETS) as claimed in claim 1 comprising steps of:
authenticating/logging into the account issuer or using virtual keys to access Global Front End System Directory (GFETSD);
searching a POS device based on the user location;
capturing a POS device Unique Identifier (UI) displayed on the physical POS enclosure or on a POS device screen;
receiving the POS device UI link wirelessly to the consumer/user FET;
automatically generating a transaction message (TM), each time when a transaction is processed by the FETS;
exchanging the TM(s) locally within the FETS and with other FETS over the networks;
generating multiple keys for each transaction; and
monitoring transactions and/or processes with alerts that are customizable by the FETS consumer/user through FETS monitor,
wherein the user/consumer needs include processing, monitoring, alerting, managing and accessing services and making payments using portable devices and access keys at physical and virtual points through issuer provided accounts,
wherein the consumer FETS and POS device are connected when the user/consumer clicks the POS device UI link, and
wherein the alerts services for the monitored transactions and/or processes is communicated according to the alerts settings configured by the FETS consumer/user.

9. The method as claimed in claim 8, wherein the consumer/user controls the processing and payment of the transaction and all accounts information of the consumer/user are kept with their accounts' issuers.

10. The method as claimed in claim 8, wherein the consumer/user can share their whole FETSD or parts of it with other FETS according to pre-defined sharing rules and conditions the FETS consumer/user creates using their FETS.
